(19) United States
(12) Patent Application Publication
(10) Pub. No.: US 2024/0008017 A1
(43) Pub. Date: Jan. 4, 2024

(54) Technique for Allocating Spatial Radio Resources for an Integrated Access and Backhaul Node

(71) Applicant: Telefonaktiebolaget LM Ericsson (publ), Stockholm (SE)

(72) Inventors: Yezi Huang, Täby (SE); Boris Dortschy, Vendelsö (SE); Lei Bao, Göteborg (SE); Magnus Åström, Lund (SE); Behrooz Makki, Pixbo (SE)

(21) Appl. No.: 18/033,139

(22) PCT Filed: Oct. 22, 2021
(86) PCT No.: PCT/SE2021/051070

§ 371 Date: Apr. 21, 2023

Related U.S. Application Data
(60) Provisional application No. 63/105,174, filed on Oct. 23, 2020.

(51) Int. Cl. H04W 72/044; H04B 7/06

(52) U.S. Cl. CPC H04W 72/046; H04W 88/08; H04B 7/0695; H04B 7/0617

(57) ABSTRACT

A network function unit (e.g., an Integrated Access and Backhaul-donor node Central Unit, IAB-donor-CU 300, an Operations Administration and Maintenance node, OAM node, or a parent node 200) configures space-domain resources in an IAB-node 100 (e.g., an IAB-Distribution Unit DU 110) with different resource sets. Each resource set may restrict certain behavior (e.g., the operation of the access unit) of the IAB-node in terms of transmission and/or reception in a certain spatial radio resource, e.g., the one or more direction units (e.g., a radio beam).

### TECHNICAL FIELD

The present disclosure relates to a technique for allocating spatial radio resources for an integrated access and backhaul node. More specifically, and without limitation, methods and devices are provided for receiving, providing, and determining an allocation of spatial radio resources for an integrated access and backhaul node (IAB-node).

### BACKGROUND

The Third Generation Partnership Project (3GPP) has specified radio networks comprising a core network (CN) and a radio access network (RAN) to provide radio access to radio devices (e.g., user equipments, UE) according to certain radio access technologies such as fourth generation Long Term Evolution (4G LTE) and fifth generation new radio (5G NR). The RAN comprises a plurality of nodes, also referred to as network nodes or base stations, each of which provides the radio access in one or more cells of the RAN.

Densification via the deployment of an increasing number of base stations, e.g., for macro cells or micro cells or nano cells, is one way to satisfy the ever-increasing demand for more and more bandwidth and/or capacity in radio networks (e.g., mobile networks). Due to the availability of more spectrum in the millimeter wave (mmw) band, deploying of small cells that operate in this band is an attractive deployment option for these purposes.

However, deploying wired connections, e.g., by means of optical fibers, to the small cells, which is the usual way in which small cells are deployed, can end up being very expensive and impractical. Thus, employing a wireless link for connecting the small cells to an operator's network (i.e., the radio network, e.g., to the RAN or the CN) is a more flexible and practical alternative with a shorter time-to-market.

An example of such a portion of the RAN with wirelessly connected nodes is an Integrated Access and Backhaul (IAB) network with IAB-nodes as the base stations. The IAB network utilizes a part of the radio resources of the RAN for its backhaul links.

However, increasing the density of such IAB-nodes can be limited by frequency reuse and interference. While it is possible to decrease the transmit power as the size of the cells is reduced, transmit power of the wireless backhaul links cannot be further reduced as the wireless backhaul links have to connect across the cells.

### SUMMARY

Accordingly, there is a need for a technique that allows densification of nodes in an radio access network without a wired backhaul link between at least some of the nodes.

As to a first method aspect, a method of receiving an allocation of spatial radio resources in an integrated access and backhaul node (IAB-node) of a radio access network (RAN) is provided. The IAB-node comprises an access unit configured to provide radio access to radio devices and child backhaul connections to child IAB-nodes, and a backhaul unit configured to provide a radio backhaul link to a parent node for operation the access unit. The method may comprise or initiate a step of any of claims 1-52.

By associating a mode of operation of with the allocated at least one spatial radio resource, the IAB-node can use or avoid the at least one spatial radio resource for the radio access in at least some embodiments. Same or further embodiments allow for resource coordination in the space-domain, e.g., a coordinated spatial domain multiplexing (SDM) that is coordinated by means of the allocation information.

The allocation information may also be referred to as a resource configuration for the access unit (e.g., the IAB-DU).

Any aspect of the technique may be implemented as a method or device for IAB space-domain resource configuration.

The technique may be implemented for 5G NR as the RAT. Embodiments of the technique can provide multi-hop relay, i.e., the backhaul link may be relayed by embodiments of the IAB-nodes. Same of further embodiments may combine the allocation of the spatial radio resources with a coordination of time and/or frequency radio resources, e.g., coordinate between the access unit and the backhaul unit of the same IAB-node or between the IAB-node and its parent node.

Alternatively or in addition, the allocation of the spatial radio resource may comprise a mode of operating the access unit and the backhaul unit so that radio access and backhaul link are multiplexed in the spatial domain.

This technique may be implemented to enable a network function unit (e.g., IAB-donor-CU, OAM, or parent node, e.g., in the third aspect) to configure space-domain resources to IAB-node (e.g., IAB-DU and/or as received in the first aspect) with different resource sets. Each resource set may restrict certain behavior (e.g., the operation of the access unit) of the IAB-node in terms of transmission and/or reception in certain spatial radio resource, e.g., the one or more direction units (e.g., a radio beam).

The first method aspect may be implemented alone or in combination with any one of claims 1 to 52.

The first method and device aspects may be implemented or embodied by the IAB-node.

As to a second method aspect, a method of providing an allocation of spatial radio resources in an integrated access and backhaul node (IAB-node) of a radio access network (RAN) is provided. The method may comprise or initiate a step of claims 1 to 52.

The second method aspect may be implemented alone or in combination with any one of claims 1 to 52.

The second method aspect may further comprise any feature and/or any step disclosed in the context of the first method aspect, or a feature and/or step corresponding thereto, e.g., a receiver counterpart to a transmitter feature or step, or vice versa.

The second method and device aspects may be implemented or embodied by the parent node of the IAB-node. The parent node may be a further embodiment of the IAB-node.

As to a third method aspect, a method of determining an allocation of spatial radio resources in an integrated access and backhaul node (IAB-node) of a radio access network (RAN) is provided. The method may comprise or initiate any step of claims 1 to 52.

The third method aspect may be implemented alone or in combination with any one of claims 1 to 52.

The third method aspect may further comprise any feature and/or any step disclosed in the context of the first and/or second method aspect, or a feature and/or step corresponding thereto, e.g., a receiver counterpart to a transmitter feature or step, or vice versa.

The third method and device aspects may be implemented or embodied by the IAB-donor of the IAB-node or a central unit associated with the IAB-node, optionally embodied by the IAB-donor or another network function unit.

The IAB-node and the parent may be spaced apart. The IAB-node and the parent may be in data communication or control communication or signal communication, e.g., exclusively by means of the radio backhaul link (briefly: backhaul link).

In any aspect, the IAB-node, the IAB-donor and the parent node may form, or may be part of, a radio network, e.g., according to the Third Generation Partnership Project (3GPP) or according to the standard family IEEE 802.11 (W-Fi). The radio network may be or may comprise a radio access network (RAN). The RAN may comprise one or more base stations (e.g., the IAB-node, the IAB-donor and the parent node). Alternatively, or in addition, the radio network may be a vehicular, ad hoc and/or mesh network. The first method aspect may be performed by one or more embodiments of the IAB-node in the radio network. The second method aspect may be performed by one or more embodiments of the IAB-node and/or parent node in the radio network. The third method aspect may be performed by one or more embodiments of the IAB-donor and/or its central unit (IAB-donor-CU).

Any of the radio devices may be a mobile or wireless device, e.g., a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Any of the radio devices may be wirelessly connected or connectable (e.g., according to a radio resource control, RRC, state or active mode) with any of the base stations. Herein, the base station may encompass any station that is configured to provide radio access to any of the radio devices. The base stations may also be referred to as transmission and reception point (TRP), radio access node or access point (AP). The base station or one of the radio devices functioning as a gateway (e.g., between the radio network and the RAN and/or the Internet) may provide a data link to a host computer providing the data. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the first, second, and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for receiving an allocation of spatial radio resources in an integrated access and backhaul node (IAB-node) of a radio access network (RAN) is provided. The IAB-node comprises an access unit configured to provide radio access to radio devices and child backhaul connections to child IAB-nodes, and a backhaul unit configured to provide a radio backhaul link to a parent node for operation the access unit. The device may be configured to perform any one of the steps of the first method aspect.

As to a further first device aspect, a device for receiving an allocation of spatial radio resources in an integrated access and backhaul node (IAB-node) of a radio access network (RAN) is provided. The device comprises processing circuitry (e.g., at least one processor and a memory). Said memory comprises instructions executable by said at least one processor whereby the device is operative to perform any one of the steps of the first method aspect.

The device aspect may be implemented alone or in combination with any one of claims 54 to 65.

As to a second device aspect, a device for providing an allocation of spatial radio resources for an integrated access and backhaul node (IAB-node) of a radio access network (RAN) is provided. The device may be configured to perform any one of the steps of the second method aspect.

As to a further second device aspect, a device for providing an allocation of spatial radio resources for an integrated access and backhaul node (IAB-node) of a radio access network (RAN) is provided. The device comprises processing circuitry (e.g., at least one processor and a memory). Said memory comprises instructions executable by said at least one processor whereby the device is operative to perform any one of the steps of the second method aspect.

The device aspect may be implemented alone or in combination with any one of claims 54 to 65.

As to a third device aspect, a device for determining an allocation of spatial radio resources for an integrated access and backhaul node (IAB-node) of a radio access network (RAN) is provided. The device may be configured to perform any one of the steps of the third method aspect.

As to a further third device aspect, a device for determining an allocation of spatial radio resources for an integrated access and backhaul node (IAB-node) of a radio access network (RAN) is provided. The device comprises processing circuitry (e.g., at least one processor and a memory). Said memory comprises instructions executable by said at least one processor whereby the device is operative to perform any one of the steps of the second method aspect.

The device aspect may be implemented alone or in combination with any one of claims 54 to 65.

Each of the devices may comprise a network node or base station functionality, e.g., in the access unit. Alternatively or in addition, each of the devices may comprise a radio device or UE functionality, e.g., in the backhaul unit.

As to a still further aspect a communication system including a host computer is provided. The host computer may comprise a processing circuitry configured to provide user data, e.g., depending on the location of the UE determined in the locating step. The host computer may further comprise a communication interface configured to forward user data to a cellular network for transmission to a user equipment (UE), wherein the UE comprises a radio interface and processing circuitry, a processing circuitry of the cellular network being configured to execute any one of the steps of the first and/or second method aspect.

The communication system may further include the UE. Alternatively, or in addition, the cellular network may further include one or more base stations and/or gateways configured to communicate with the UE and/or to provide a data link between the UE and the host computer using the first method aspect and/or the second method aspect.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the UE, the base station, the system or any node or station for embodying the technique may further include any feature disclosed in the context of the method aspects, and vice versa. Particularly, any one of the units and modules, or a dedicated unit or module, may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for receiving an allocation of spatial radio resources in an integrated access and backhaul node;

FIG. 2 shows a schematic block diagram of an embodiment of a device for providing an allocation of spatial radio resources in an integrated access and backhaul node;

FIG. 3 shows a schematic block diagram of an embodiment of a device for determining an allocation of spatial radio resources in an integrated access and backhaul node;

FIG. 4 shows an example flowchart for a method of receiving an allocation of spatial radio resources in an integrated access and backhaul node, which method may be implementable by the device of FIG. 1;

FIG. 5 shows an example flowchart for a method of providing an allocation of spatial radio resources in an integrated access and backhaul node, which method may be implementable by the device of FIG. 2;

FIG. 6 shows an example flowchart for a method of determining an allocation of spatial radio resources in an integrated access and backhaul node, which method may be implementable by the device of FIG. 3;

FIG. 7 shows a schematic environment for an example of a radio network comprising embodiments of the devices of FIGS. 1 to 3;

FIG. 8 schematically illustrates an example of RAN comprising embodiments of the devices of FIGS. 1 to 3;

FIG. 9 schematically illustrates an example of an IAB architecture, which may be implemented by embodiments of the devices of FIGS. 1 to 3;

FIGS. 10A and FIG. 10B show examples of an IAB topology;

FIG. 11 schematically illustrates an example for the RAN comprising multiple parent nodes embodying device of FIG. 2;

FIG. 12 schematically illustrates an radio network with examples of space-domain resource conditions around embodiments of the devices of FIGS. 1 and 2.

FIG. 13 shows an example schematic block diagram of a IAB-node embodying the device of FIG. 1;

FIG. 14 shows an example schematic block diagram of a parent node embodying the device of FIG. 2;

FIG. 15 shows an example schematic block diagram of a network function unit or IAB-donor-CU embodying the device of FIG. 3;

FIG. 16 schematically illustrates an example telecommunication network connected via an intermediate network to a host computer;

FIG. 17 shows a generalized block diagram of a host computer communicating via a base station or radio device functioning as a gateway with a user equipment over a partially wireless connection; and

FIGS. 18 and 19 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including 3GPP LTE (e.g., LTE-Advanced or a related radio access technique such as MulteFire), in a Wireless Local Area Network (WLAN) according to the standard family IEEE 802.11, for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

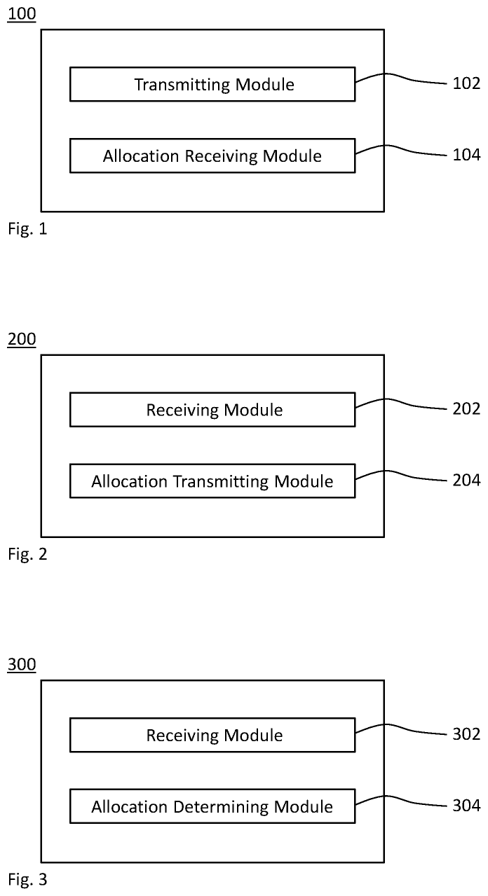

FIG. 1 schematically illustrates an example block diagram of a device according to the first device aspect. The device is generically referred to by reference sign 100.

The device 100 may comprise any one of a transmitting module 102 and an allocation receiving module 104 for performing the steps labelled 402, 404, and 406, respectively, preferably according to the list of embodiments or any embodiment disclosed herein.

Any of the modules of the device 100 may be implemented by units configured to provide the corresponding functionality.

The device 100 may also be referred to as, or may be embodied by, the IAB-node. The device 100 and any other network node (e.g., a base station of the RAN, e.g., the parent node and/or the IAB-donor) may be in a radio communication (preferably using the 3GPP interface Uu).

FIG. 2 schematically illustrates an example block diagram of a device according to the second device aspect. The device is generically referred to by reference sign 200.

The device 200 may comprise any one of a receiving module 202 and an allocation transmitting module 204 for performing the steps labelled 502 and 504, respectively, preferably according to the list of embodiments or any embodiment disclosed herein.

Any of the modules of the device 200 may be implemented by units configured to provide the corresponding functionality.

The device 200 may also be referred to as, or may be embodied by, the parent node. The device 200 and any other network node (e.g., a base station of the RAN, e.g., the IAB-node and/or the IAB-donor) may be in a radio communication (preferably using the 3GPP interface UU).

FIG. 3 schematically illustrates an example block diagram of a device according to the third device aspect. The device is generically referred to by reference sign 300.

The device 300 may comprise any one of a receiving module 302 and an allocation determination module 304 for performing the steps labelled 602 and 604, respectively, preferably according to the list of embodiments or any embodiment disclosed herein.

Any of the modules of the device 300 may be implemented by units configured to provide the corresponding functionality.

The device 300 may also be referred to as, or may be embodied by, the IAB-donor or IAB-CU. The device 300 and any other network node (e.g., a base station of the RAN, e.g., the IAB-node and/or the IAB-parent node) may be in a radio communication (preferably using the 3GPP interface Uu).

The technique may be applied to uplink (UL), downlink (DL) or direct communications between radio devices, e.g., device-to-device (D2D) communications or sidelink (SL) communications.

Herein, any radio device may be a mobile or portable station and/or any radio device wirelessly connectable to the network node (e.g., a base station) and/or the RAN, or to another radio device. A radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP sidelink connection. Furthermore, any base station may be a station providing radio access, may be part of a radio access network (RAN) and/or may be a node connected to the RAN for controlling radio access. Further a base station may be an access point, for example a W-Fi access point.

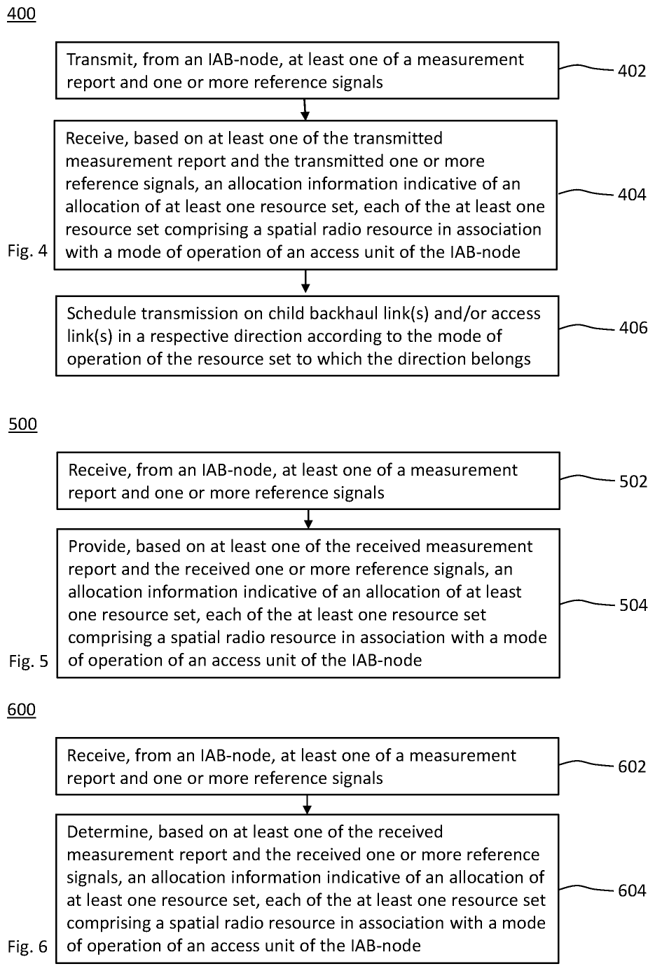

FIG. 4 shows an example flowchart for a method 400 according to the first method aspect in the list of embodiments.

The method 400 may be performed by the device 100. For example, the modules 102 and 104 may perform the steps 402, 404, and 406, respectively.

FIG. 5 shows an example flowchart for a method 500 according to the second method aspect in the list of embodiments.

The method 500 may be performed by the device 200. For example, the units 202 and 204 may perform the steps 502 and 504, respectively.

FIG. 6 shows an example flowchart for a method 600 according to the second method aspect in the list of embodiments.

The method 600 may be performed by the device 300. For example, the units 302 and 304 may perform the steps 602 and 604, respectively.

In any aspect, the technique may be applied to uplink (UL), downlink (DL) or direct communications between radio devices, e.g., device-to-device (D2D) communications or sidelink (SL) communications.

Each of the devices 100, 200, and 200 may be embodied by a radio device and/or a base station.

Herein, any radio device may be a mobile or portable station and/or any radio device wirelessly connectable to a base station or RAN, or to another radio device. A radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP sidelink connection. Furthermore, any base station may be a station providing radio access, may be part of a radio access network (RAN) and/or may be a node connected to the RAN for controlling radio access. Further a base station may be an access point, for example a W-Fi access point.

The technique may implement at least some of the features of Integrated Access and Backhaul (IAB).

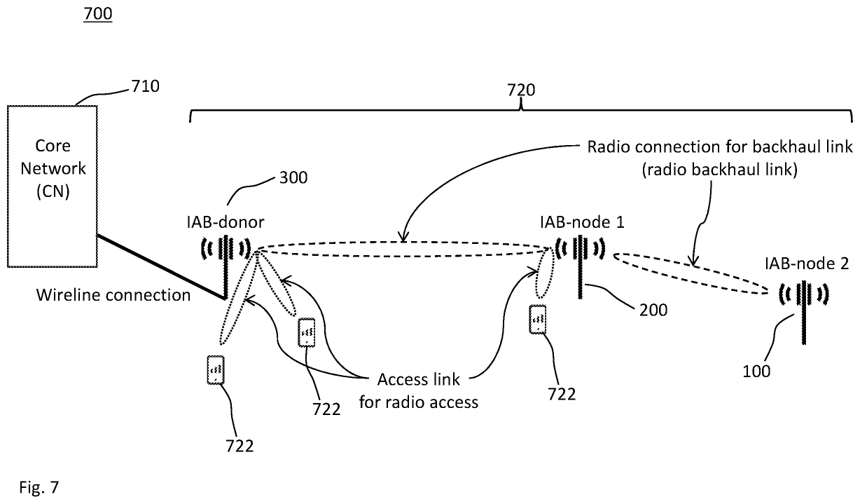

FIG. 7 shows a schematic environment for a radio network 700 comprising embodiments of the devices 100, 200 and 300 in a RAN 720. The RAN is connected to a core network 710. For example, FIG. 7 schematically illustrates a multi-hop deployment in an integrated access and backhaul (IAB) network 700.

In FIG. 7, an IAB deployment that supports multiple hops is presented. The IAB-donor node 300 (in short: IAB-donor 300) has a wired connection to the CN 710 and the IAB-nodes 100 and 200 are wirelessly connected using NR to the IAB-donor as the radio backhaul link, either directly or indirectly via another IAB-node 200. The connection between IAB-donor 300 and/or the IAB-nodes 100, 200 on one hand and UEs 722 on the other hand is called access link or radio access, while the connection between two IAB-nodes 100, 200 or between an IAB-donor 300 and an IAB-node 100 or 200 is called (radio) backhaul link.

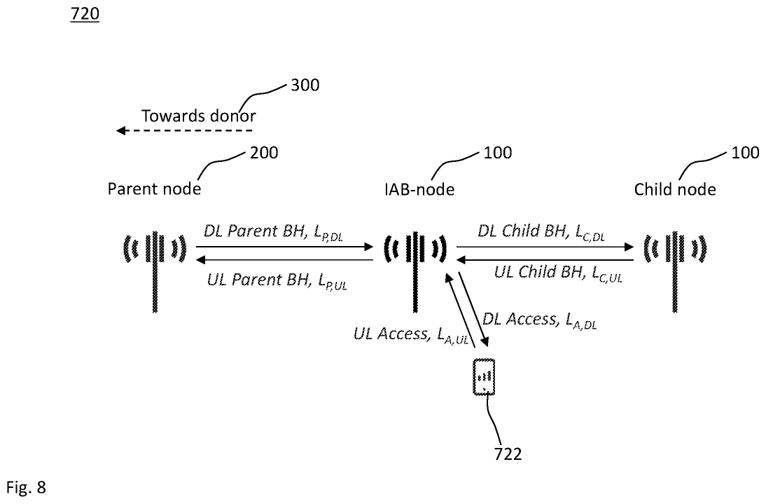

FIG. 8 schematically illustrates a RAN 720 comprising an IAB network. For example, FIG. 8 schematically illustrates IAB terminologies in adjacent hops.

Furthermore, as shown in FIG. 8, the adjacent upstream node 200, which is closer to the IAB-donor node 300 of an IAB-node 100, is referred to as a parent node 200 of the IAB-node 100. The adjacent downstream node 100, which is further away from the IAB-donor node 300 of an IAB-node 100 or 200 is referred to as a child node of the IAB-node. The backhaul link between the parent node 200 and the IAB-node 100 is referred to as parent (backhaul) link. The backhaul link between the IAB-node 100 and the child node 100 is referred to as child (backhaul) link.

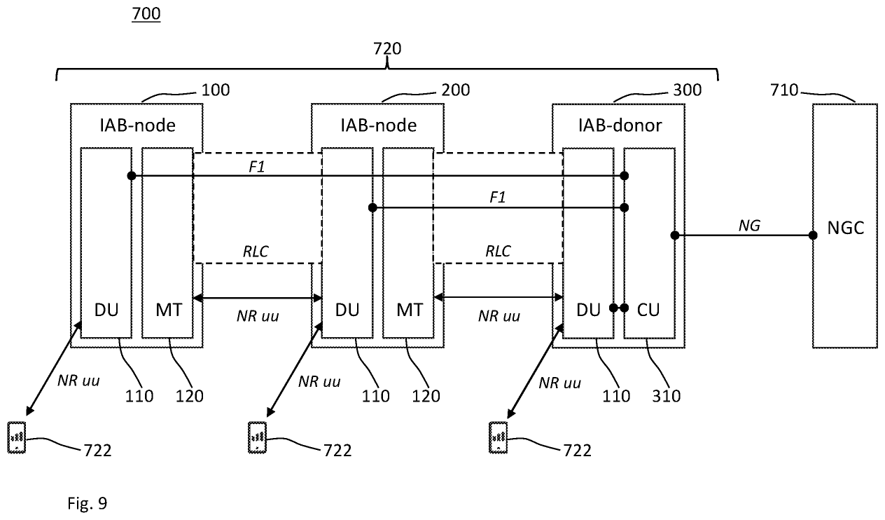

Any embodiment may implement at least some features of an IAB architecture. FIG. 9 schematically illustrates an example of the IAB architecture. Without limitation thereto, the base station may be a gNB.

As one major difference of the IAB architecture compared to Release 10 LTE relay (besides lower layer differences) is that the IAB architecture adopts the Central-Unit/Distributed-Unit (CU/DU) split of gNBs 100, 200 or 300, in which time-critical functionalities are realized in the access unit 110, e.g., the IAB-DU (in the following also DU), closer to the radio, whereas the less time-critical functionalities are pooled in the IAB-donor-CU 310 with the opportunity for centralization.

Based on this architecture, an IAB-donor 300 comprises both CU function 310 and DU function 110 (i.e., an access unit). In particular, the IAB-donor-CU 310 comprises all CU functions of the IAB-nodes 100 and 200 under the same IAB-donor 300.

Each IAB-node 100, 200 then hosts the DU functions 110 of a gNB. In order to be able to transmit/receive wireless signals to/from the upstream IAB-node or IAB-donor, each IAB-node has a mobile termination (IAB-MT, in the following also MT), a logical unit providing a necessary set of UE-like functions. Via the IAB-DU, the IAB-node establishes RLC-channel to UEs and/or to MTs of the connected IAB-node(s). Via the IAB-MT, the IAB-node establishes the backhaul radio interface towards the serving IAB-node or IAB-donor.

FIG. 9 shows a schematic diagram for a two-hop chain of IAB-nodes 100 and 200 under an IAB-donor 300.

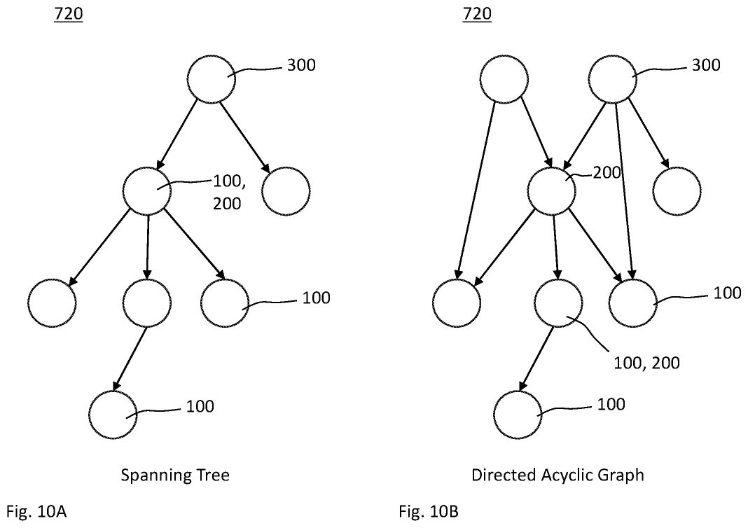

Any embodiment may implement at least some features of an IAB topology. FIGS. 10A and 10B schematically illustrates examples of the IAB topologies.

Wireless backhaul links are vulnerable to blockage, e.g., due to moving objects such as vehicles, due to seasonal changes (foliage), severe weather conditions (rain, snow or hail), or due to infrastructure changes (new buildings). Such vulnerability also applies to IAB-nodes 100, 200 and 300. Also, traffic variations can create uneven load distribution on wireless backhaul links leading to local link or node congestion. In view of those concerns, the IAB topology supports redundant paths as another difference compared to the 3GPP Release 10 for an LTE relay.

The following topologies are applicable in the IAB network as the RAN 720, as schematically shown in FIGS. 10A and 10B, respectively: A Spanning tree (ST) and a Directed acyclic graph (DAG).

FIG. 10A and FIG. 10B show examples for ST and DAG, respectively. The arrow indicates the directionality of the graph edge.

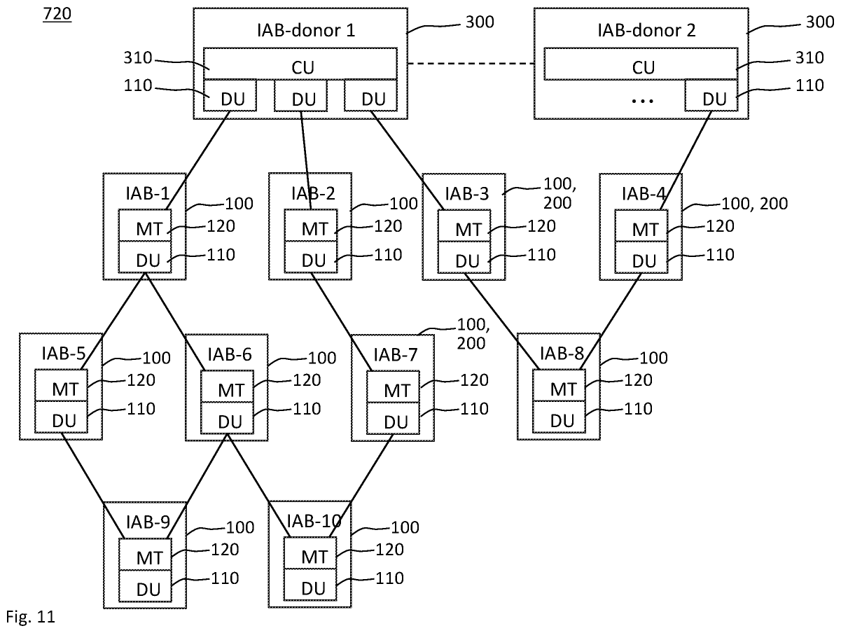

It means that one IAB-node 100, 200 or 300 can have multiple child nodes 100 and/or one IAB-node 100, 200 may have multiple parent nodes 200. Particularly regarding multi-parent topology, different scenarios may be considered as shown in FIG. 11.

FIG. 11 schematically illustrates an example for the RAN 720. For example:
IAB-9 connects to IAB-donor 1 via two parent nodes IAB-5 and IAB-6 which connect to the same grandparent (of IAB-9) node IAB-1;
IAB-10 connects to IAB-donor 1 via two parent nodes IAB-6 and IAB-7 which connect to different grandparent (of IAB-9) nodes IAB-1 and IAB-2;
IAB-8 connects to two parent nodes IAB-3 and IAB-4 which connect to different IAB donor nodes IAB-donor 1 and IAB-donor 2.

FIG. 11 illustrates an IAB multi-parent scenarios. The multi-connectivity or route redundancy may be used for back-up purposes. It is also possible that redundant routes are used concurrently, e.g., to achieve load balancing, reliability, etc.

Any embodiment of the technique may apply radio resource (briefly: resource) coordination.

For example, the mode of operation, as defined or configured by means of the allocation information, may comprise at least some features of the following time-domain resource configuration.

In case of in-band operation, the IAB-node 100 or 200 is typically subject to the half-duplex constraint, i.e., an IAB-node can only be in either transmission or reception mode at a time. Rel-16 IAB mainly consider the time-division multiplexing (TDM) case where the MT and DU resources of the same IAB-node are separated in time. Based on this consideration, the following resource types have been defined for IAB MT and DU, respectively.

From an IAB-node MT 120 point-of-view, e.g., as in 3GPP Release 15, the following time-domain resources may be indicated for the parent link:
Downlink (DL) time resource
Uplink (UL) time resource
Flexible (F) time resource

From an IAB-node DU 110 point-of-view, the child link may have the following types of time resources:
DL time resource
UL time resource
F time resource
Not-available (NA) time resources (resources not to be used for communication on the DU child links)

Each of the downlink, uplink and flexible time-resource types of the DU child link can belong to one of two categories:
Hard (H): The corresponding time resource is always available for the DU child link
Soft (S): The availability of the corresponding time resource for the DU child link is explicitly and/or implicitly controlled by the parent node.

The IAB-DU resources are configured per cell, and the H/S/NA attributes for the DU resource configuration are explicitly indicated per-resource type (D/U/F) in each slot. As a result, the semi-static time-domain resources of the DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relation between MT and DU resources are listed in below Table.

The following table indicates examples of a coordination between radio resources used by MT 120 and DU 110 of an IAB-node.

| | | MT configuration | | |
|---|---|---|---|---|
| | | DL | UL | Flexible |
| DU | DL-H | DU: can transmit on | DU: can transmit on | DU: can transmit on |
| configuration | | DL unconditionally; | DL unconditionally; | DL unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL & UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL & UL. |
| | F-H | DU: can transmit on | DU: can transmit on | DU: can transmit on |
| | | DL or schedule UL | DL or schedule UL | DL or schedule UL |
| | | unconditionally; | unconditionally; | unconditionally; |
| | | MT: not available. | MT: not available. | MT: not available. |
| | F-S | DU: can transmit on | DU: can transmit on | DU: can transmit on |
| | | DL or schedule UL | DL or schedule UL | DL or schedule UL |
| | | conditionally; | conditionally; | conditionally; |
| | | MT: available on DL. | MT: available on UL. | MT: available on DL & UL. |
| | NA | DU: not available; | DU: not available; | DU: not available; |
| | | MT: available on DL. | MT: available on UL. | MT: available on DL & UL. |

Furthermore, an IAB-DU function 110 may correspond to multiple cells, including cells operating on different carrier frequencies. Similarly, an IAB-MT function 120 may correspond to multiple carrier frequencies. This can either be implemented by one IAB-MT unit 120 operating on multiple carrier frequencies, or be implemented by multiple IAB-MT units 120, each operating on different carrier frequencies. The H/S/NA attributes for the per-cell DU resource configuration and should take into account the associated IAB-MT one or more carrier frequencies. One example of such IAB-DU configuration is shown in below Table.

The following Table indicates examples of time-domain resource configuration for the DU 110.

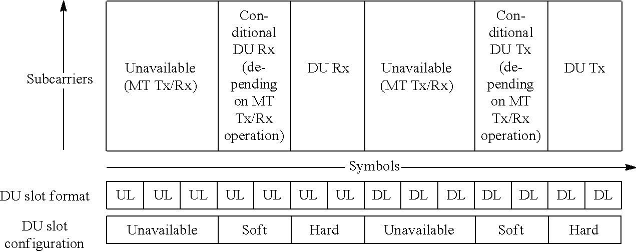

Any embodiment, e.g., in the resource set, may comprise at last some features of the following frequency-domain resource configuration.

One of the objectives in 3GPP Release 17 IAB WID RP-193251 [RP-201293, New WID on Enhancements to Integrated Access and Backhaul, Qualcomm, RAN #88e, June 2020] is to have “specification of enhancements to the resource multiplexing between child and parent links of an IAB node, including: support of simultaneous operation (transmission and/or reception) of IAB-node's child and parent links (i.e., MT Tx/DU Tx, MT Tx/DU Rx, MT Rx/DU Tx, MT Rx/DU Rx).”

This may be implemented in any embodiment by providing a frequency-domain resource configuration. Comparing to the time-domain counterpart, one example of the frequency-domain DU resource configuration is shown in below Table.

The following Table illustrates examples of frequency-domain DU resource configuration.

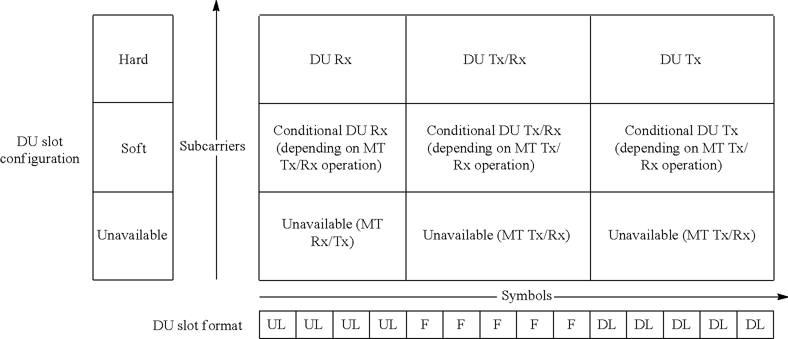

Any aspect of the technique may be implemented in accordance with or as an extension of the 3GPP TS 38.213, version 16.3.0.

Backhaul and access links of an IAB-DU 110 may be exposed to different channel environment depending on which direction the IAB-DU is transmitting to or receiving from.

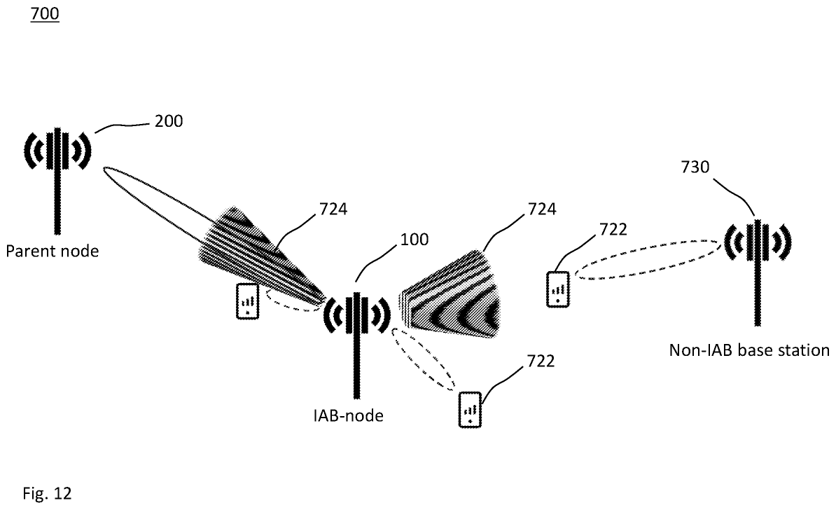

An example is shown in FIG. 12. It is beneficial from the network performance perspective if the IAB-DU 110 can adapt its behavior to individually suit each of the conditions.

This may be implemented by means of the allocation information being indicative of spatial radio resources 724.

In a first variant of any embodiment, the shaded cone on the right-hand-side marks the direction units 724 or beam units (briefly: directions) of which the IAB-DU 110 may suffer from strong interferences that are not controllable in the IAB network 720, such as from a non-IAB base station 730 if the IAB-DU is receiving from a UE or a child node, or the directions which are barred/reserved for other purpose by the network. The allocation information may specify that the IAB-DU can or has to avoid transmission and/or reception to/from those directions 724. Put another way, the allocation information may specify that the directions are restricted.

In a second variant of any embodiment, the shaded cone on the left-hand-side marks the directions 724 in which the transmission of IAB-DU 110 (to and/or from a UE 722, for example) impacts the communication to another node 200 in the IAB network 720. In the example of FIG. 12, they are the transmission directions, if used by the IAB-DU 110, that will cause unacceptable performance degradation of connections to the parent node 200 of the co-located IAB-MT 120. Resource coordination in time- and/or frequency-domain between IAB-DU 110 and IAB-MT 120 or the impacted network node 200 regarding transmission in those directions may be configured by means of the allocation information.

In a third variant of any embodiment, in the remaining directions, the IAB-DU 120 does not interfere to a substantial degree with the parent IAB-DU or other RAN nodes. In this case, IAB-DU and IAB-MT can operate in space-domain multiplexing (SDM) if hardware supports and handles any potential interferers internally in the scheduler. IAB-DU can transmit or receive according to the configured DL, UL or Flexible in those directions using allocated time and frequency resources.

Any of the variants are combinable.

FIG. 12 schematically illustrates an example of space-domain resource conditions around an IAB-node.

In the subject technique, the space around an IAB-node is divided into multiple direction units. The network function unit and the IAB-node have a common understanding of the direction units. A set of direction units can compose a cone-like shape (defined by angles both in azimuth and vertical) with its axis of symmetry in certain direction or direction of certain reference beam.

In one embodiment, the direction unit can be certain backhaul link or access link.

In one embodiment, the direction unit uses a beam on which SSB beams are transmitted and received as a reference direction or reference directions. The reference SSB beam can be the one pointing to an absolute direction (e.g., towards the parent node or the IAB-donor), or the one pointing to a relative direction (e.g., used in initial access or random access). The reference SSB beam can also be updated during the network operation (e.g., the latest beam used by the IAB-node to communicate with the parent node, or in the measurement object configured by the IAB-donor-CU).

In one embodiment, the reference direction can be CSI-RS beams or SRS beams.

In one embodiment, the reference direction is the beam used for PDCCH or PDSCH.

In one embodiment, the direction unit 724 can be grouped with respect to beamformers. An absolute reference direction can be for example pointing towards the IAB-donor. A relative reference direction can be for example the latest communicated CSI-RS beam.

In one embodiment, the IAB-node receives from the parent node a set of beams, e.g., among its transmitted SSB beams, for which spatial restrictions apply. In another embodiment, the IAB-node receives a restriction requirement, e.g., a cone angle or an SINR level relative to the reference beam, for which beams affected by the restriction (within the cone or below the SINR level).

In another embodiment, the direction unit can be grouped or defined by or with respect to Uplink or Downlink codebooks, including but not limited to standardized codebooks.

In another embodiment, the common understanding of the reference beam direction can be agreed by using an iterative learning procedure, between the network function unit and the IAB-node.

The technique may comprise at least one of the following methods at the IAB-node 100, e.g., according to the first aspects.

A method in an IAB-node 100 comprising of an IAB-MT 120 and an IAB-DU 110 may comprise the step 402 of sending capability and interference measurements to a network function unit.

The network function unit 300 may be an IAB-donor-CU 310 or other centralized or distributed function unit 300, e.g., an OAM or a parent node 200.

The capability and interference measurements may be associated with a certain direction unit index.

The capability measurement may comprise spatial domain multiplexing (SDM) between IAB-MT 120 and IAB-DU 110 regarding part of or all direction units.

The SDM capability may be determined based on whether or not the SINR on the involved links served by IAB-MT and IAB-DU exceeds certain threshold.

The interference measurement may covers part of or all direction units.

Alternatively or in addition, the step 404 may comprise receiving an allocation of one or multiple of the resource sets, each resource set containing one or multiple or a set of direction units following a defined mode of operation for IAB-DU 110.

The resource sets with defined mode of operation may include at least one of the following sets.

Set 1: IAB-DU cannot transmit or receive in the direction units; Set 1 may contain one or more subsets.

Set 1-1: IAB-DU cannot transmit in the direction units.

Set 1-2: IAB-DU cannot receive in the direction units.

Set 2: IAB-DU conditionally transmits and/or receives in the direction units based on configured DL/UL/Flexible time and/or frequency resources.

The condition can be based on resource coordination with IAB-MT and/or parent node. For example, IAB-DU transmits and/or receives according to time- or frequency-domain H/S/NA configuration or a combination of time- and frequency-domain H/S/NA configurations if provided.

In a variant, the IAB-DU transmits and/or receives only if the performance of the parent backhaul link is not changed due to a transmission or reception by the IAB-DU.

Direction units without allocation to any of the resource sets can be treated as in Set 2. In other words, the Set 2 may define a default operation if the spatial radio resources is not in the allocation information.

Set 3: IAB-DU transmits and/or receives in the direction units based on the configured DL/UL/Flexible.
The resource sets can be configured cell-specific.
The resource sets can be configured carrier-specific.
Alternatively, or in addition, method 400 may comprise scheduling (step 406) transmission on child backhaul link(s) and/or access link(s) in respective direction according to the mode of operation of the resource set which the direction belongs to.

Any embodiment may comprise methods at the parent node 200, e.g., according to the second aspect.

Corresponding embodiments as the above can be identified on the parent node side which performs as the network function unit. For example, the parent node can perform the following steps:

The step 502 may comprise receiving a reference signal or set of reference signals.

This may, e.g., be that:

(Option A) the parent node receives the SSBs from the IAB-node. From this reference beam and/or expectations of a certain modulation and coding scheme (MCS) in communications with all other IAB-nodes 100, 200 or 300, or UEs 722 associated with the parent node 200, the parent node 200 may determine a subset within the set of reference signals for which restrictions (i.e., certain modes of operation) should apply. The subset within the reference signals may comprise received SSBs from the IAB-node 100, which should be excluded because inference might be too strong.

(Option B) If the IAB-node uses digital beamforming, the node can use a single reference beam, compared to which other beams may not interfere more than a certain interference level.

In the step 504, the parent node 200 may then signal a configuration for the IAB-node that its IAB-DU must adhere to, e.g., including the following restriction requirements e.g., in terms of (Option A) Communication on beams that belongs to the subset of beams, or deviates less than a threshold in direction compared to a “worst case” beam.

(Option B) A beam exceeding an interference threshold relative to a reference beam. If the beam interferes less than the threshold value it may be freely scheduled (i.e., be configured in Set 3), otherwise it must adhere to a restricted scheduling requirement either in time, frequency or both time and frequency (i.e., be configured in Set 2).

Any embodiment may further comprise methods at IAB-donor-CU 310, e.g., according to the third aspect.

Corresponding embodiments as the above can be identified on the IAB-donor-CU side which performs as the network function unit. For example, the IAB-donor-CU 310 may perform at least one of the following steps:
(optionally) receives network topology and planning data from for example the OAM unit.
receives capability from the IAB node.
(optionally) configures measurement objects to perform interference measurement.
(optionally) receives measurement reports/results on configured measurement objects.
(optionally) receives dedicated interference report from the parent node of the IAB node.
determines the resource sets based on the combined information of the network topology and the overall interference condition.
sends the resource allocation sets to the IAB node.

In one embodiment, the resource configuration and/or resource coordination from the IAB-donor-CU 310 to the IAB-DU uses F1AP interface.

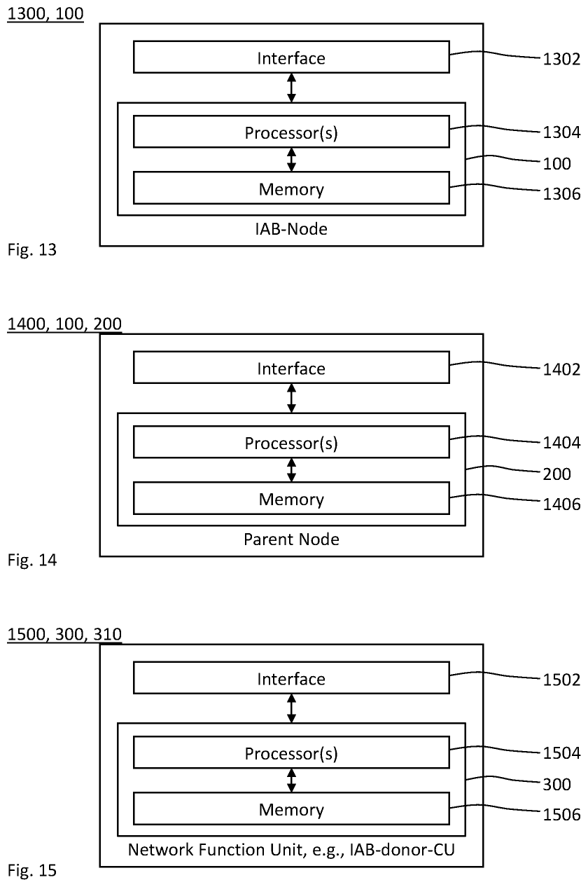

FIG. 13 shows a schematic block diagram for an embodiment of the device 100. The device 100 comprises processing circuitry, e.g., one or more processors 1304 for performing the method 300 and memory 1306 coupled to the processors 1304. For example, the memory 1306 may be encoded with instructions that implement at least one of the modules 102 and 104.

The one or more processors 1304 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1306, IAB-node functionality. For example, the one or more processors 1304 may execute instructions stored in the memory 1306. Such functionality may include providing various features and steps discussed herein, including any of the benefits disclosed herein. The expression “the device being operative to perform an action” may denote the device 100 being configured to perform the action.

As schematically illustrated in FIG. 13, the device 100 may be embodied by an IAB-node 1300, e.g., functioning as a base station and/or, concerning its backhaul link, as a UE. The IAB-node 1300 comprises a radio interface 1302 (e.g., the antenna system) coupled to the device 100 for radio communication with one or more nodes, e.g., functioning as a base station or a UE.

FIG. 14 shows a schematic block diagram for an embodiment of the device 200. The device 200 comprises processing circuitry, e.g., one or more processors 1404 for performing the method 300 and memory 1406 coupled to the processors 1404. For example, the memory 1406 may be encoded with instructions that implement at least one of the modules 202 and 204.

The one or more processors 1404 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1406, parent node functionality and/or IAB-node functionality. For example, the one or more processors 1404 may execute instructions stored in the memory 1406. Such functionality may include providing various features and steps discussed herein, including any of the benefits disclosed herein. The expression “the device being operative to perform an action” may denote the device 200 being configured to perform the action.

As schematically illustrated in FIG. 14, the device 200 may be embodied by a parent node 1400, e.g., functioning as a base station and/or IAB-node. The parent node 1400 comprises a radio interface 1402 (e.g., the antenna system) coupled to the device 200 for radio communication with one or more nodes, e.g., functioning as a IAB-node or IAB-donor or a UE.

FIG. 15 shows a schematic block diagram for an embodiment of the device 300. The device 300 comprises processing circuitry, e.g., one or more processors 1504 for performing the method 400 and memory 1506 coupled to the processors 1504. For example, the memory 1506 may be encoded with instructions that implement at least one of the modules 302 and 304.

The one or more processors 1504 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 1506, IAB-donor functionality or IAB-donor-CU functionality. For example, the one or more processors 1504 may execute instructions stored in the memory 1506. Such functionality may include providing various features and steps discussed herein, including any of the benefits disclosed herein. The expression “the device being operative to perform an action” may denote the device 300 being configured to perform the action.

As schematically illustrated in FIG. 15, the device 300 may be embodied by an IAB-donor 1500 or its central unit (CU), e.g., functioning as a base station and/or as a parent node of the IAB-node and/or as a central unit of the IAB-node and/or as a central unit of the parent node. The IAB-donor or IAB-donor-CU 1500 comprises a radio interface 1502 (e.g., the antenna system) coupled to the device 300 for radio communication with one or more nodes, e.g., functioning as a IAB-nodes or child nodes relative to IAB-donor and/or with a UE.

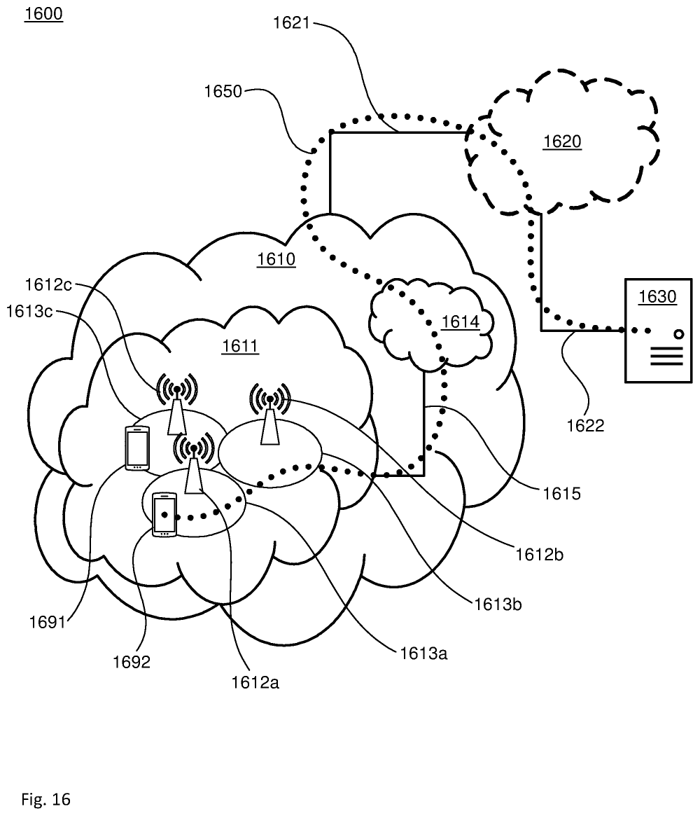

With reference to FIG. 16, in accordance with an embodiment, a communication system 1600 includes a telecommunication network 1610, such as a 3GPP-type cellular network, which comprises an access network 1611, such as a radio access network, and a core network 1614. The access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to the core network 1614 over a wired or wireless connection 1615. A first user equipment (UE) 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Any of the base stations 1612 and the UEs 1691, 1692 may embody the device 100.

The telecommunication network 1610 is itself connected to a host computer 1630, which may be embodied in the hardware and/or software of a standalone server, a cloud-implemented server, a distributed server or as processing resources in a server farm. The host computer 1630 may be under the ownership or control of a service provider, or may be operated by the service provider or on behalf of the service provider. The connections 1621, 1622 between the telecommunication network 1610 and the host computer 1630 may extend directly from the core network 1614 to the host computer 1630 or may go via an optional intermediate network 1620. The intermediate network 1620 may be one of, or a combination of more than one of, a public, private or hosted network; the intermediate network 1620, if any, may be a backbone network or the Internet; in particular, the intermediate network 1620 may comprise two or more sub-networks (not shown).

The communication system 1600 of FIG. 16 as a whole enables connectivity between one of the connected UEs 1691, 1692 and the host computer 1630. The connectivity may be described as an over-the-top (OTT) connection 1650. The host computer 1630 and the connected UEs 1691, 1692 are configured to communicate data and/or signaling via the OTT connection 1650, using the access network 1611, the core network 1614, any intermediate network 1620 and possible further infrastructure (not shown) as intermediaries. The OTT connection 1650 may be transparent in the sense that the participating communication devices through which the OTT connection 1650 passes are unaware of routing of uplink and downlink communications. For example, a base station 1612 need not be informed about the past routing of an incoming downlink communication with data originating from a host computer 1630 to be forwarded (e.g., handed over) to a connected UE 1691. Similarly, the base station 1612 need not be aware of the future routing of an outgoing uplink communication originating from the UE 1691 towards the host computer 1630.

By virtue of at least one of the methods 400, 500, and 600 being performed by any one of the UEs 1691 or 1692 and/or any one of the base stations 1612, the performance or range of the OTT connection 1650 can be improved, e.g., in terms of increased throughput and/or reduced latency. More specifically, the host computer 1630 may indicate to the RAN 720 or any one of the devices 100, 200, and 300 (e.g., on an application layer) the QoS of the traffic or other traffic parameters, which may control or influence the operation of the access unit 110 in accordance with the operation mode defined by the resource set.

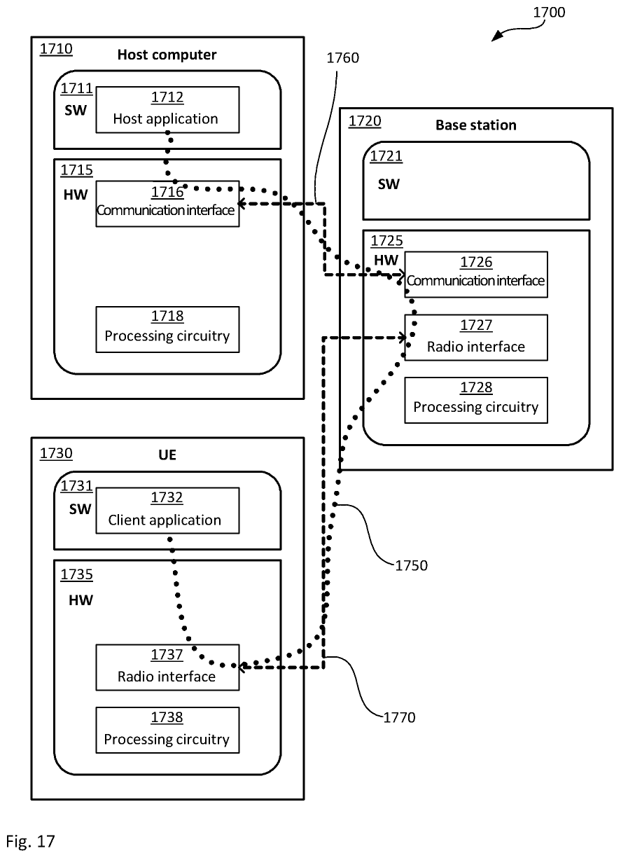

Example implementations, in accordance with an embodiment of the UE, base station and host computer discussed in the preceding paragraphs, will now be described with reference to FIG. 17. In a communication system 1700, a host computer 1710 comprises hardware 1715 including a communication interface 1716 configured to set up and maintain a wired or wireless connection with an interface of a different communication device of the communication system 1700. The host computer 1710 further comprises processing circuitry 1718, which may have storage and/or processing capabilities. In particular, the processing circuitry 1718 may comprise one or more programmable processors, application-specific integrated circuits, field programmable gate arrays or combinations of these (not shown) adapted to execute instructions. The host computer 1710 further comprises software 1711, which is stored in or accessible by the host computer 1710 and executable by the processing circuitry 1718. The software 1711 includes a host application 1712. The host application 1712 may be operable to provide a service to a remote user, such as a UE 1730 connecting via an OTT connection 1750 terminating at the UE 1730 and the host computer 1710. In providing the service to the remote user, the host application 1712 may provide user data, which is transmitted using the OTT connection 1750. The user data may depend on the location of the UE 1730. The user data may comprise auxiliary information or precision advertisements (also: ads) delivered to the UE 1730. The location may be reported by the UE 1730 to the host computer, e.g., using the OTT connection 1750, and/or by the base station 1720, e.g., using a connection 1760.

The communication system 1700 further includes a base station 1720 provided in a telecommunication system and comprising hardware 1725 enabling it to communicate with the host computer 1710 and with the UE 1730. The hardware 1725 may include a communication interface 1726 for setting up and maintaining a wired or wireless connection with an interface of a different communication device of the communication system 1700, as well as a radio interface 1727 for setting up and maintaining at least a wireless connection 1770 with a UE 1730 located in a coverage area (not shown in FIG. 17) served by the base station 1720. The communication interface 1726 may be configured to facilitate a connection 1760 to the host computer 1710. The connection 1760 may be direct, or it may pass through a core network (not shown in FIG. 17) of the telecommunication system and/or through one or more intermediate networks outside the telecommunication system. In the embodiment shown, the hardware 1725 of the base station 1720 further includes processing circuitry 1728, which may comprise one or more programmable processors, application-specific integrated circuits, field programmable gate arrays or combinations of these (not shown) adapted to execute instructions. The base station 1720 further has software 1721 stored internally or accessible via an external connection.

The communication system 1700 further includes the UE 1730 already referred to. Its hardware 1735 may include a radio interface 1737 configured to set up and maintain a wireless connection 1770 with a base station serving a coverage area in which the UE 1730 is currently located. The hardware 1735 of the UE 1730 further includes processing circuitry 1738, which may comprise one or more programmable processors, application-specific integrated circuits, field programmable gate arrays or combinations of these (not shown) adapted to execute instructions. The UE 1730 further comprises software 1731, which is stored in or accessible by the UE 1730 and executable by the processing circuitry 1738. The software 1731 includes a client application 1732. The client application 1732 may be operable to provide a service to a human or non-human user via the UE 1730, with the support of the host computer 1710. In the host computer 1710, an executing host application 1712 may communicate with the executing client application 1732 via the OTT connection 1750 terminating at the UE 1730 and the host computer 1710. In providing the service to the user, the client application 1732 may receive request data from the host application 1712 and provide user data in response to the request data. The OTT connection 1750 may transfer both the request data and the user data. The client application 1732 may interact with the user to generate the user data that it provides.

It is noted that the host computer 1710, base station 1720 and UE 1730 illustrated in FIG. 17 may be identical to the host computer 1630, one of the base stations 1612a, 1612b, 1612c and one of the UEs 1691, 1692 of FIG. 16, respectively. This is to say, the inner workings of these entities may be as shown in FIG. 17, and, independently, the surrounding network topology may be that of FIG. 16.

In FIG. 17, the OTT connection 1750 has been drawn abstractly to illustrate the communication between the host computer 1710 and the UE 1730 via the base station 1720, without explicit reference to any intermediary devices and the precise routing of messages via these devices. Network infrastructure may determine the routing, which it may be configured to hide from the UE 1730 or from the service provider operating the host computer 1710, or both. While the OTT connection 1750 is active, the network infrastructure may further take decisions by which it dynamically changes the routing (e.g., on the basis of load balancing consideration or reconfiguration of the network).

The wireless connection 1770 between the UE 1730 and the base station 1720 is in accordance with the teachings of the embodiments described throughout this disclosure. One or more of the various embodiments improve the performance of OTT services provided to the UE 1730 using the OTT connection 1750, in which the wireless connection 1770 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1750 between the host computer 1710 and UE 1730, in response to variations in the measurement results. The measurement procedure and/or the network functionality for reconfiguring the OTT connection 1750 may be implemented in the software 1711 of the host computer 1710 or in the software 1731 of the UE 1730, or both. In embodiments, sensors (not shown) may be deployed in or in association with communication devices through which the OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of the OTT connection 1750 may include message format, retransmission settings, preferred routing etc.; the reconfiguring need not affect the base station 1720, and it may be unknown or imperceptible to the base station 1720. Such procedures and functionalities may be known and practiced in the art. In certain embodiments, measurements may involve proprietary UE signaling facilitating the host computer's 1710 measurements of throughput, propagation times, latency and the like. The measurements may be implemented in that the software 1711, 1731 causes messages to be transmitted, in particular empty or “dummy” messages, using the OTT connection 1750 while it monitors propagation times, errors etc.

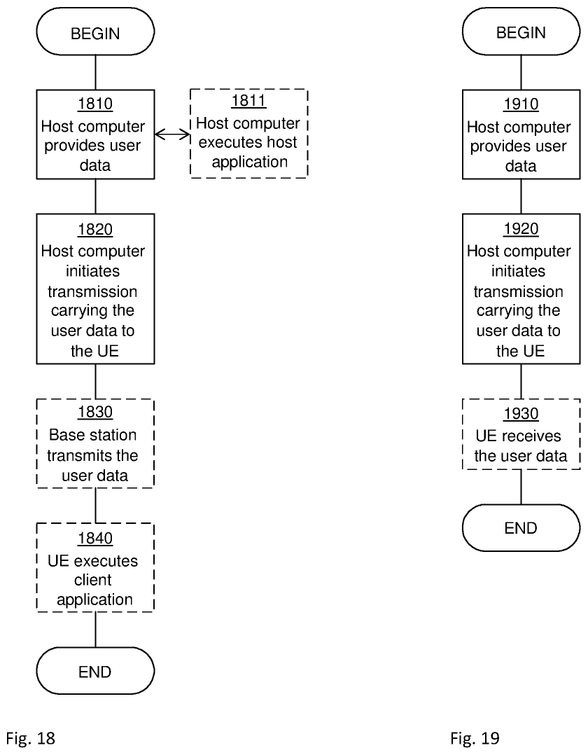

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this paragraph. In a first step 1810 of the method, the host computer provides user data. In an optional substep 1811 of the first step 1810, the host computer provides the user data by executing a host application. In a second step 1820, the host computer initiates a transmission carrying the user data to the UE. In an optional third step 1830, the base station transmits to the UE the user data which was carried in the transmission that the host computer initiated, in accordance with the teachings of the embodiments described throughout this disclosure. In an optional fourth step 1840, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this paragraph. In a first step 1910 of the method, the host computer provides user data. In an optional substep (not shown) the host computer provides the user data by executing a host application. In a second step 1920, the host computer initiates a transmission carrying the user data to the UE. The transmission may pass via the base station, in accordance with the teachings of the embodiments described throughout this disclosure. In an optional third step 1930, the UE receives the user data carried in the transmission.

As has become apparent from above description, at least some embodiments of the technique allow for an (e.g., improved) coordination of the space-domain resources around an IAB-node, optionally considering different channel conditions and communication demands in different directions. Based on those factors, space-domain resources may be divided into different resource sets defined with certain communication behavior (e.g., the mode of operation of the access unit). Benefit from, e.g., increased degrees of freedom in scheduling and reduced interference, the radio network (e.g., the RAN) can achieve better performance in terms of both system capacity and latency. Additionally, those of ordinary skill in the art will readily appreciate that while the backhaul unit (120) and the access unit (110) may be connected to the same antenna system of the IAB-node (100) for providing the backhaul link and the radio access, other embodiments of the present disclosure connect the backhaul unit (120) and the access unit (110) to different antenna systems. Additionally, the IAB-node (100) can be configured according to one embodiment of the present disclosure to measure reference signals received from the parent node (200).

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following embodiments.

1-85. (canceled).

86. A method of receiving an allocation of spatial radio resources (in an integrated access and backhaul node (IAB-node) of a radio access network (RAN), the IAB-node comprising an access unit configured to provide radio access to radio devices and child backhaul connections to child IAB-nodes, and a backhaul unit configured to provide a radio backhaul link to a parent node, the method comprising:
the IAB-node transmitting at least one of a measurement report and one or more reference signals; and
receiving, based on at least one of the transmitted measurement report and the transmitted one or more reference signals, allocation information indicating an allocation of at least one resource set, wherein each of the at least one resource set comprises a spatial radio resource in association with a mode of the operation of the access unit.

87. The method of claim 86, wherein the spatial radio resource in each of the at least one resource set comprises or corresponds to one or more direction units, and wherein the space around the IAB-node is divided into multiple direction units.

88. The method of claim 86, wherein the spatial radio resource in each of the at least one resource set corresponds to a subset of the space around the IAB-node, wherein the spatial radio resource in each of the at least one resource set corresponds to a beamforming pattern.

89. The method of claim 86, wherein the backhaul unit and the access unit are connected to the same antenna system of the IAB-node for providing the backhaul link and the radio access, respectively.

90. The method of claim 86, wherein the one or more reference signals are transmitted on one or more reference beams, and wherein the spatial radio resource or the one or more direction units in each of the at least one resource set corresponds to one or more of the reference beams, and wherein the reference signals comprise at least one of:
a synchronization signal block (SSB);
a channel state information reference signal (CSI-RS); and
a sounding reference signal (SRS).

91. The method of claim 86, wherein the spatial resource or the one or more direction units in one of the at least one resource set corresponds to the radio backhaul link provided by the backhaul unit, wherein the backhaul unit is an IAB-MT of the IAB-node and is configured to provide the backhaul link using radio resources of the RAN, or an access link for the radio access, or a child backhaul link, provided by the access unit.

92. The method of claim 86, wherein the measurement report indicates a capability of the access unit to transmit and/or receive on one or more of the spatial radio resources or in one or more of the direction units, and an extent to which such transmitting and receiving would interfere with each other.

93. The method of claim 86, wherein the allocation information indicates at least one resource set comprising a spatial radio resource, and wherein the associated mode of operation for the access unit is that the spatial radio resource is not used for transmission and/or reception, the method further comprising:
providing radio access to at least one of the radio devices via the access unit in the mode of operation that is associated, according to the at least one resource set, with a spatial radio resource that is used or avoided in the radio access.

94. The method of claim 86, wherein the allocation information indicates at least one resource set comprising a spatial radio resource that is used by the backhaul unit, and wherein the associated mode of operation for the access unit is that the spatial radio resource is not available and/or that the spatial radio resource is used by coordinate frequency resources and/or time resources with at least one of the backhaul unit and the parent node.

95. The method of claim 86, wherein the allocation information indicates at least one resource set comprising a spatial radio resource that is not used by an access unit of the parent node and/or another node of the RAN, and wherein the associated mode of operation comprises the access unit and the backhaul node performing space-domain multiplexing,
whereby the access unit transmits or receives in the spatial resource according to a configured DL, UL, or Flexible allocated time and frequency resources.

96. The method of claim 86, wherein the one or more reference signals are transmitted from the IAB-node to the parent node for the allocation of the at least one resource set.

97. The method of claim 86, wherein the one or more reference signals are transmitted from the IAB-node to the parent node for:
measuring the reference signal at the parent node;
the allocation of the at least one resource set; and/or
sending a measurement report indicative of a result of the measurement from the parent node to the network function unit.

98. The method of claim 86, wherein the allocation information is received from the parent node at the IAB-node or received from the network function unit relayed through the parent node.

99. The method of claim 86, wherein the allocation information indicates at least one resource set comprising a spatial radio resource for which the access unit and the backhaul unit perform spatial domain multiplexing (SDM) according to the associated mode of operation, and wherein the spatial radio resource for the SDM is determined by:
a signal to noise ratio; or
a signal to noise and interference ratio; or
a signal to interference ratio that does not exceed a predefined or configured threshold.

100. The method of claim 86, wherein the at least one resource set restricts operation so that the access unit cannot transmit or receive in the associated spatial radio resource.

101. The method of claim 86, wherein the at least one resource set is such that the access unit conditionally transmits and/or receives using the associated spatial radio resource based on configured time and/or frequency resources, and is further configured to be used for DL, or for UL, or for being flexible, wherein the condition for conditionally using the associated spatial radio resource is based on resource coordination with at least one of the backhaul unit and/or the parent node, and wherein the access unit transmits and/or receives according to a time-domain and/or frequency-domain configuration.

102. The method of claim 86, wherein the at least one resource set is such that the access unit conditionally transmits and/or receives using the associated spatial radio resource, and wherein the condition for the conditional usage is that the access unit transmits and/or receives only if a performance of the backhaul link to the parent node is not changed due to a transmission or reception by the access node.

103. The method of claim 86, wherein the at least one resource set is such that the access unit transmits and/or receives using the associated spatial radio resource based on configured time and/or frequency resources, and is further configured for:
a downlink (DL);
an uplink (UL); or
to be flexible.

104. A method of providing an allocation of spatial radio resources for an integrated access and backhaul node (IAB-node) of a radio access network (RAN), the IAB-node comprising a Distributed Unit (DU) configured to provide radio access to User Equipment (UEs) and child backhaul connections to child IAB-nodes, and a mobile terminal (MT) unit configured to provide parent backhaul connections to parent IAB-nodes, the method comprising:
receiving, from the IAB-node, at least one of a measurement report and one or more reference signals; and
providing, to the IAB-node and based on at least one of the received measurement report and the received one or more reference signals, allocation information indicating an allocation of at least one resource set, each of the at least one resource set comprising a spatial radio resource associated with a mode of the operation of the access unit.

105. A device for receiving an allocation of spatial radio resources for an integrated access and backhaul node (IAB-node) of a radio access network (RAN), wherein the IAB-node comprises a Distributed unit (DU) configured to provide radio access to UEs and child backhaul connections to child IAB-nodes, and a mobile terminal (MT) unit configured to provide a parent backhaul connection to a parent IAB-node, the device comprising.
processing circuitry; and
memory operatively connected to the processing circuitry and comprising instructions that, when executed by the processing circuitry, causes the processing circuitry to:
transmit at least one of a measurement report and one or more reference signals; and
receive, based on at least one of the transmitted measurement report and the transmitted one or more reference signals, allocation information indicative of an allocation of at least one resource set, each of the at least one resource set comprising a spatial radio resource in association with a mode of the operation of the access unit.
